(19) United States
(12) Patent Application Publication
(10) Pub. No.: US 2012/0327635 A1
(43) Pub. Date: Dec. 27, 2012

(54) Flashing light safety helmet

(76) Inventor: Stephen Henry Roache, Phila, PA (US)

(21) Appl. No.: 13/068,142

(22) Filed: Jun. 27, 2011

(51) Int. Cl. F21V 21/084

(52) U.S. Cl. 362/105

(57) ABSTRACT

The FIGS. 1 and 2 illustrate a flashing light safety helmet Of general height, weight, width and length of Standard safety helmets.

While the invention has been particularly shown And described with respect to the illustrated embodiments thereof, It will be understood by those skilled in the art That the foregoing and other changes in form and details May be made therein without departing from The spirit and scope of the invention.

### BACKGROUND OF THE INVENTION

This invention relates to apparatus for head and neck safety.

Use of this flashing light safety helmet, will go a very long way Toward the protection of the wearer, by making the wearer very Visible at greater distances in most weather conditions be it night or day.

### SUMMARY OF THE INVENTION

The present invention is directed to apparatus for several different Applications dealing with safety. The flashing light safety helmet will come in different widths, lengths And sizes to accommodate adults, teenagers and children.

These and other features, aspects and advantages of the present invention, Will become better understood with references to the following Drawings, descriptions and claims.

### BRIEF DESCRIPTION OF THE DRAWINGS

FIG. 1 illustrates a perspective elevation view of the front of the Flashing light safety helmet according to an embodiment of the invention.

FIG. 2 illustrates a side view of the flashing light safety helmet According to an embodiment of the invention.

### DETAIED DESCRIPTION

The following detailed description represents the best currently Contemplated modes for carrying out the invention. The description is not to be taken in a limited sense. But is made merely for the purpose of illustrating the general Principles of the invention.

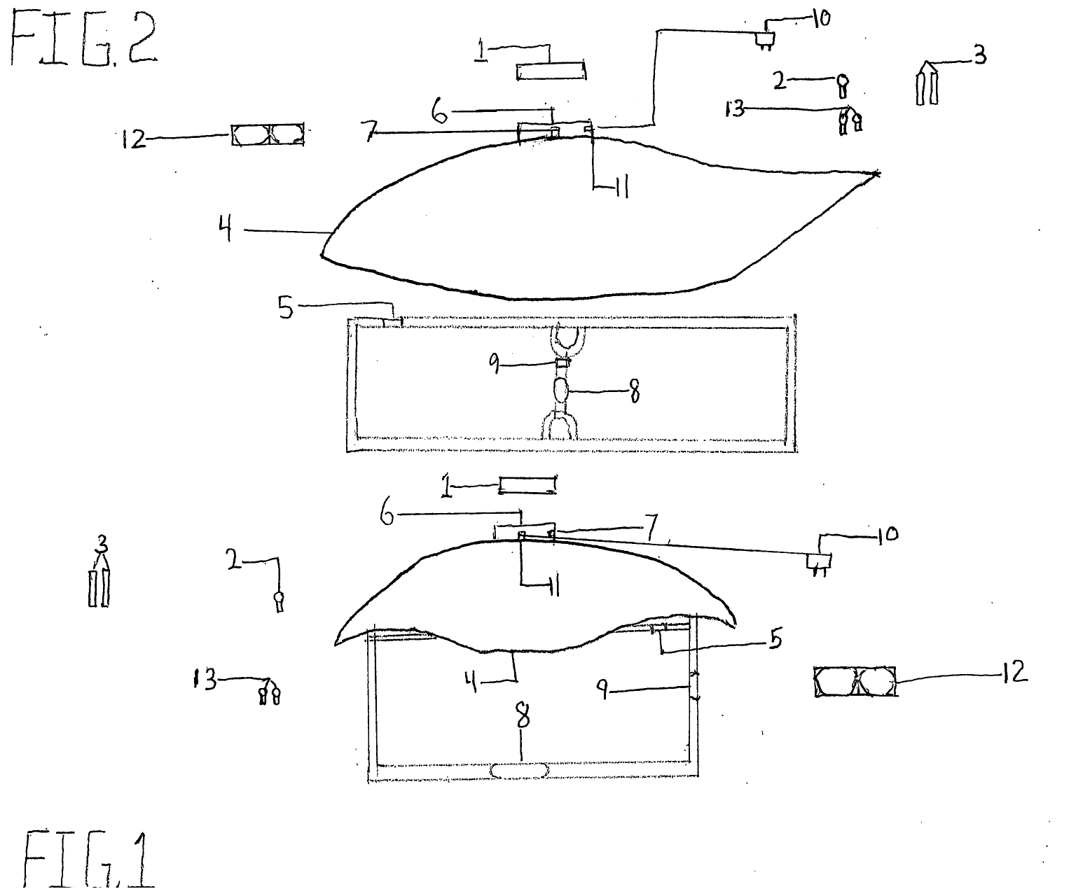

1. Referring to safety
FIGS. 1 and 2 have a flashing light safety helmet
May have a body 4
That may be made of plastic or like rigid material.
For example, the body 4 may have a variety of separation distances inside the body 4
For fit and comfort 5 may fit inside 4 and connect 4 to 5
And have an adjustable head and chin strap for fit and comfort.
The body 4 may come in different styles, sizes and colors
For example the flashing light safety helmet 4—
May have a clear cover 1—xenon halogen bulb 2—and
Two double A batteries 3—battery housing 6—on and off switch 7—
Outlet for battery charger 11—battery charger 10—
Adjustable head strap 5—adjustable chin strap 9—chin guard 8—(AVAILABLE TO LAW ENFORCEMENT ONLY)
The flashing light safety helmet 4—may feature,
Two xenon halogen bulbs 13—and a blue and red cover 12.
